(19) United States
(12) Patent Application Publication
(10) Pub. No.: US 2018/0323859 A1
(43) Pub. Date: Nov. 8, 2018

(54) WIRELESS DATA TRANSFER BETWEEN SERVERS

(71) Applicant: Lenovo Enterprise Solutions (Singapore) Pte. Ltd., Singapore (SG)

(72) Inventors: Pravin Patel, Cary, NC (US); Theodore Brian Vojnovich, Raleigh, NC (US); Gregory B. Pruett, Raleigh, NC (US); Luke Remis, Raleigh, NC (US)

(21) Appl. No.: 15/586,181

(22) Filed: May 3, 2017

(51) Int. Cl. H04B 7/155; H04W 76/02

(52) U.S. Cl. CPC H04B 7/155; H04W 76/02

(57) ABSTRACT

A method, according to one embodiment, includes: establishing, by a server, a direct wireless connection with a second server, receiving, by the server, designation of the server as an aggregator in response to a result of an evaluation of characteristics of the server and the second server, establishing, by the server, a network connection between the server and a network access point, and receiving, by the server, data from the second server via the direct wireless connection and sending the data to the network access point via the network connection. Other systems, methods, and computer program products are described in additional embodiments.

### FIELD OF THE INVENTION

The present invention relates to server management, and more particularly, this invention relates to establishing a wireless connection between servers that may be used to manage each of the servers.

### BACKGROUND

A server typically includes a computer program or a device that provides functionality for other programs or devices. This style of architecture allows for a single computation to be distributed across multiple processes or devices. As such, servers can provide various functionalities.

Moreover, remote access to and/or control over a server is achieved by coupling the server to an Ethernet access connection. However, multiple servers may be stored in a given rack (or chassis), where some racks are able to hold forty servers or more. Thus, a rack storing forty servers may have forty wired Ethernet connections, each leading to a switch somewhere in the rack. With such a large number of cables, there is increased likelihood of crossed or faulty cables, and airflow may be impeded as it exits the rack. In addition, the footprint of the connectors has an impact on density and may dictate how many servers can be fit in a particular system.

Thus, it would be beneficial to provide systems, methods, computer program products and the like which overcome these wired server shortcomings. Accordingly, the ability to manage multiple servers in a rack without the need for a cabled connection to each server would be desirable.

### SUMMARY

A method, according to one embodiment, includes: establishing, by a server, a direct wireless connection with a second server, receiving, by the server, designation of the server as an aggregator in response to a result of an evaluation of characteristics of the server and the second server, establishing, by the server, a network connection between the server and a network access point, and receiving, by the server, data from the second server via the direct wireless connection and sending the data to the network access point via the network connection.

A computer program product, according to another embodiment, includes a computer readable storage medium having program instructions embodied therewith, the program instructions executable by a server to perform a method comprising: establishing, by the server, a direct wireless connection with a second server, receiving, by the server, designation of the server as an aggregator in response to a result of an evaluation of characteristics of the server and the second server, establishing, by the server, a network connection between the server and a network access point, and receiving, by the server, data from the second server via the direct wireless connection and sending the data to the network access point via the network connection.

A method, according to yet another embodiment, includes: establishing a direct wireless connection between two or more servers, evaluating characteristics of the two or more servers for designating one of the servers as an aggregator, establishing a network connection between the server designated as the aggregator and a network access point, and using the server designated as the aggregator as an intermediary for data transfer between other ones of the servers connected to the server designated as the aggregator via the direct wireless connection, and the network access point.

Other aspects and advantages of the present invention will become apparent from the following detailed description, which, when taken in conjunction with the drawings, illustrate by way of example the principles of the invention.

### BRIEF DESCRIPTION OF THE DRAWINGS

FIG. 1 is a schematic drawing of a computer network environment, according to one approach.

FIG. 2 is a simplified schematic of a computing workstation, according to one embodiment.

FIG. 3 is an exemplary system, according to one embodiment.

FIG. 4 is a flowchart of a method, according to one embodiment.

FIG. 5 is a flowchart of a method, according to one embodiment.

FIG. 6 is a flowchart of sub-processes, in accordance with one embodiment

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

The following description discloses several preferred embodiments of implementing wireless connections to servers and/or related systems and methods. Accordingly, some of the embodiments described herein introduce the ability to manage multiple servers in a rack without the need for a cabled connection to each server, as will be described in further detail below.

In one general embodiment, a method includes: establishing, by a server, a direct wireless connection with a second server, receiving, by the server, designation of the server as an aggregator in response to a result of an evaluation of characteristics of the server and the second server, establishing, by the server, a network connection between the server and a network access point, and receiving, by the server, data from the second server via the direct wireless connection and sending the data to the network access point via the network connection.

In another general embodiment, a computer program product includes a computer readable storage medium having program instructions embodied therewith, the program instructions executable by a server to perform a method comprising: establishing, by the server, a direct wireless connection with second server, receiving, by the server, designation of the server as an aggregator in response to a result of an evaluation of characteristics of the server and the second server, establishing, by the server, a network connection between the server and a network access point, and receiving, by the server, data from the second server via the direct wireless connection and sending the data to the network access point via the network connection.

In yet another general embodiment, a method includes: establishing a direct wireless connection between two or more servers, evaluating characteristics of the two or more servers for designating one of the servers as an aggregator, establishing a network connection between the server designated as the aggregator and a network access point, and using the server designated as the aggregator as an intermediary for data transfer between other ones of the servers connected to the server designated as the aggregator via the direct wireless connection, and the network access point.

General Computing Concepts

The description herein is presented to enable any person skilled in the art to make and use the invention and is provided in the context of particular applications of the invention and their requirements. Various modifications to the disclosed embodiments will be readily apparent to those skilled in the art and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

In particular, various embodiments of the invention discussed herein are implemented using the Internet as a means of communicating among a plurality of computer systems. One skilled in the art will recognize that the present invention is not limited to the use of the Internet as a communication medium and that alternative methods of the invention may accommodate the use of a private intranet, a Local Area Network (LAN), a Wide Area Network (WAN) or other means of communication. In addition, various combinations of wired, wireless (e.g., radio frequency) and optical communication links may be utilized.

The program environment in which one embodiment of the invention may be executed illustratively incorporates one or more general-purpose computers or special-purpose devices such hand-held computers. Details of such devices (e.g., processor, memory, and data storage, input and output devices) are well known and are omitted for the sake of clarity.

It should also be understood that the techniques of the present invention might be implemented using a variety of technologies. For example, the methods described herein may be implemented in software running on a computer system, or implemented in hardware utilizing one or more processors and logic (hardware and/or software) for performing operations of the method, application specific integrated circuits, programmable logic devices such as Field Programmable Gate Arrays (FPGAs), and/or various combinations thereof. In one illustrative approach, methods described herein may be implemented by a series of computer-executable instructions residing on a storage medium such as a physical (e.g., non-transitory) computer-readable medium. In addition, although specific embodiments of the invention may employ object-oriented software programming concepts, the invention is not so limited and is easily adapted to employ other forms of directing the operation of a computer.

The invention can also be provided in the form of a computer program product comprising a computer readable storage or signal medium having computer code thereon, which may be executed by a computing device (e.g., a processor) and/or system. A computer readable storage medium can include any medium capable of storing computer code thereon for use by a computing device or system, including optical media such as read only and writeable CD and DVD, magnetic memory or medium (e.g., hard disk drive, tape), semiconductor memory (e.g., FLASH memory and other portable memory cards, etc.), firmware encoded in a chip, etc.

A computer readable signal medium is one that does not fit within the aforementioned storage medium class. For example, illustrative computer readable signal media communicate or otherwise transfer transitory signals within a system, between systems e.g., via a physical or virtual network, etc.

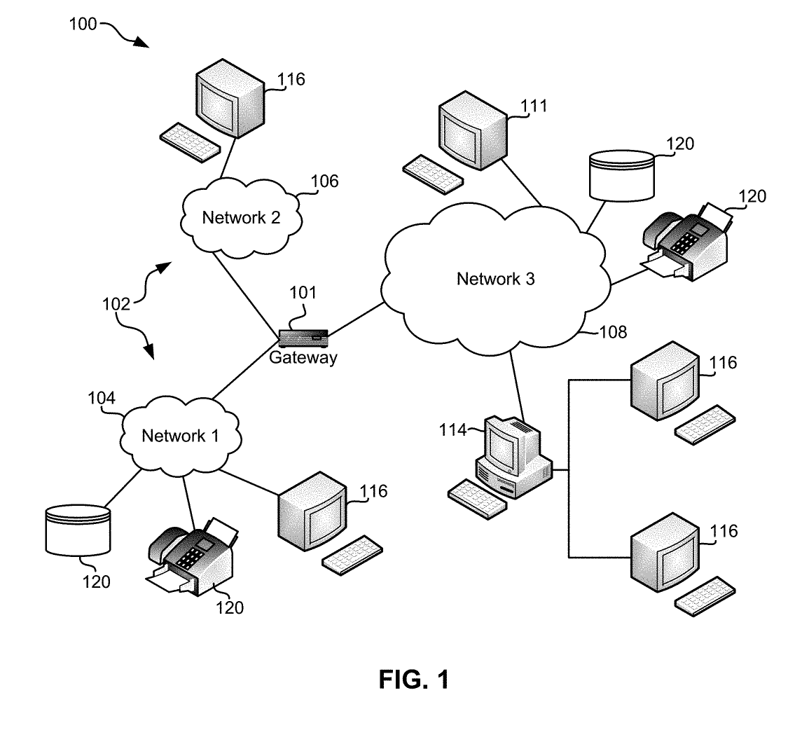

FIG. 1 illustrates an architecture 100, in accordance with one embodiment. As an option, the present architecture 100 may be implemented in conjunction with features from any other embodiment listed herein, such as those described with reference to the other FIGS. Of course, however, such architecture 100 and others presented herein may be used in various applications and/or in permutations which may or may not be specifically described in the illustrative embodiments listed herein. Further, the architecture 100 presented herein may be used in any desired environment.

As shown in FIG. 1, a plurality of remote networks 102 are provided including a first remote network 104 and a second remote network 106. A gateway 101 may be coupled between the remote networks 102 and a proximate network 108. In the context of the present network architecture 100, the networks 104, 106 may each take any form including, but not limited to a LAN, a WAN such as the Internet, public switched telephone network (PSTN), internal telephone network, etc.

In use, the gateway 101 serves as an entrance point from the remote networks 102 to the proximate network 108. As such, the gateway 101 may function as a router, which is capable of directing a given packet of data that arrives at the gateway 101, and a switch, which furnishes the actual path in and out of the gateway 101 for a given packet.

Further included is at least one data server 114 coupled to the proximate network 108, and which is accessible from the remote networks 102 via the gateway 101. It should be noted that the data server(s) 114 may include any type of computing device/groupware. Coupled to each data server 114 is a plurality of user devices 116. Such user devices 116 may include a desktop computer, laptop computer, hand-held computer, printer or any other type of logic. It should be noted that a user device 111 may also be directly coupled to any of the networks, in one embodiment.

A peripheral 120 or series of peripherals 120, e.g. facsimile machines, printers, networked storage units, etc., may be coupled to one or more of the networks 104, 106, 108. It should be noted that databases, servers, and/or additional components may be utilized with, or integrated into, any type of network element coupled to the networks 104, 106, 108. In the context of the present description, a network element may refer to any component of a network.

According to some approaches, methods and systems described herein may be implemented with and/or on virtual systems and/or systems which emulate one or more other systems, such as a UNIX system which emulates a MAC OS environment, a UNIX system which virtually hosts a MICROSOFT WINDOWS environment, a MICROSOFT WINDOWS system which emulates a MAC OS environment, etc. This virtualization and/or emulation may be enhanced through the use of VMWARE software, in some embodiments.

In more approaches, one or more networks 104, 106, 108, may represent a cluster of systems commonly referred to as a “cloud.” In cloud computing, shared resources, such as processing power, peripherals, software, data processing and/or storage, servers, etc., are provided to any system in the cloud, preferably in an on-demand relationship, thereby allowing access and distribution of services across many computing systems. Cloud computing typically involves an Internet or other high speed connection (e.g., 4G LTE, fiber optic, etc.) between the systems operating in the cloud, but other techniques of connecting the systems may also be used.

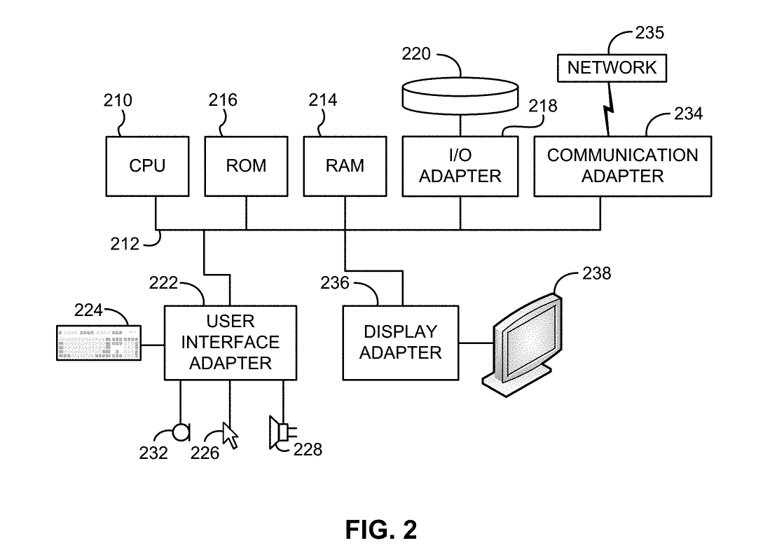

FIG. 2 shows a representative hardware environment associated with a user device 116 and/or server 114 of FIG. 1, in accordance with one embodiment. Such figure illustrates a typical hardware configuration of a workstation having a central processing unit 210, such as a microprocessor, and a number of other units interconnected via a system bus 212.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen and a digital camera (not shown) to the bus 212, communication adapter 234 for connecting the workstation to a communication network 235 (e.g., a data processing network) and a display adapter 236 for connecting the bus 212 to a display device 238.

The workstation may have resident thereon an operating system such as the Microsoft WINDOWS Operating System (OS), a MAC OS, a UNIX OS, etc. It will be appreciated that a preferred embodiment may also be implemented on platforms and operating systems other than those mentioned. A preferred embodiment may be written using JAVA, XML, C, and/or C++ language, or other programming languages, along with an object oriented programming methodology. Object oriented programming (OOP), which has become increasingly used to develop complex applications, may be used.

Moreover, a system according to various embodiments may include a processor and logic integrated with and/or executable by the processor, the logic being configured to perform one or more of the process steps recited herein. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

As previously mentioned, server racks (or chassis) having wired connections to each of multiple servers stored therein causes an increased likelihood of crossed or faulty cables, and airflow may be impeded as it exits the rack. In addition, the footprint of the wired connections has a negative impact on achievable server density and may therefore dictate (limit) how many servers can ultimately be accommodated in a particular system. In addition, implementing wired connections to each of the servers included in a given rack increases costs and resource consumption.

Thus, it would be beneficial to provide systems, methods, computer program products and the like which overcome these wired server shortcomings. Accordingly, the ability to manage multiple servers in a rack without the need for a cabled connection to each server is desirable, as will be described in further detail below.

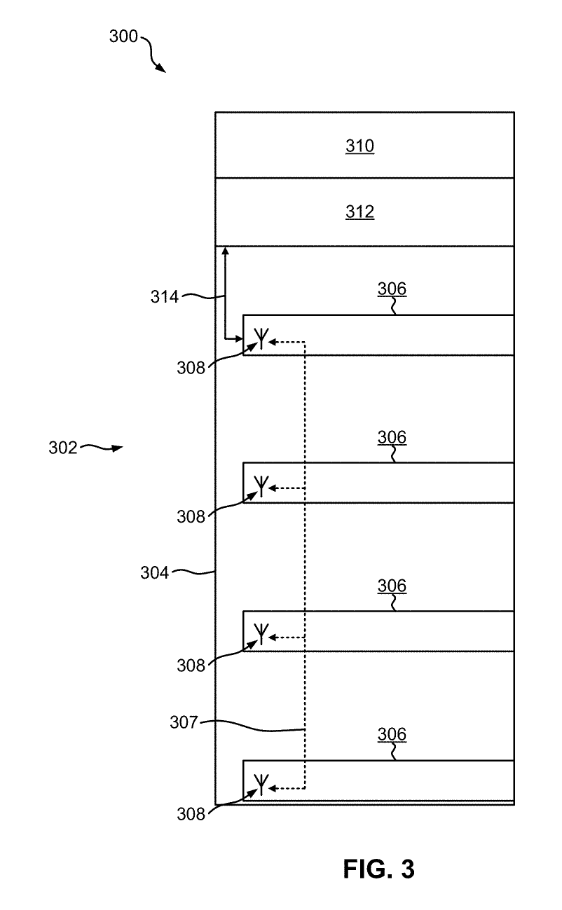

Looking to FIG. 3, a system 300 having a server rack 302 is illustrated in accordance with one embodiment. As an option, the present system 300 may be implemented in conjunction with features from any other embodiment listed herein, such as those described with reference to the other FIGS., such as FIGS. 1-2. However, such system 300 and others presented herein may be used in various applications and/or in permutations which may or may not be specifically described in the illustrative embodiments listed herein. Further, the system 300 presented herein may be used in any desired environment. Thus FIG. 3 (and the other FIGS.) may be deemed to include any possible permutation.

Again, system 300 includes a server rack 302 which has an enclosure 304. The server rack 302 may have any configuration. In an illustrative embodiment, the server rack 302 is compliant with a standard set by the Electronic Industries Association, such as standard EIA-310.

Servers 306 may be stored (e.g., housed) in the server rack 302, preferably such that they are positioned in the enclosure 304. Moreover, each of the servers 306 may be coupled to a common enclosure 304. However, it is preferred, but in no way required, that the servers 306 are not coupled to each other by a physical electrical connection.

Depending on the dimensions and configuration of the server rack 302, a varied number of servers 306 may be able to be stored therein. For example, as previously mentioned, a server rack may be able to store about forty servers. It should be noted that the spacing shown between each of the servers 306 included in server rack 302 is in no way intended to be limiting, but rather is presented by way of example. It follows that multiple servers may be implemented in a given server rack with a greater or lower density than shown, e.g., depending on the desired embodiment.

Each of the servers 306 are shown as including a wireless communication device 308 of known type, which may preferably be used to establish a direct wireless connection between any two or more of the servers 306. Moreover, according to some approaches, servers 306 may include a basepoint management controller (not shown), which may be used to manage and/or report the relative health (e.g., performance) of the server. Moreover, it should be noted that according to the present description, a “direct wireless connection” may include any type of wireless connection that is established using a protocol that may not rely on an intervening wireless access point. Any suitable protocol may be used, e.g., such as Bluetooth, near field communication, Wi-Fi Direct, etc. However, in some approaches the wireless communication devices 308 of the servers 306 may be used to establish wireless connections that do implement a wireless access point, e.g., such as a Wi-Fi connection.

Dashed line 307 has been included to provide a representation of the direct wireless connection that may be formed between wireless communication devices 308 of the servers 306 according to an illustrative approach. However, depending on the particular embodiment, the direct wireless connection may vary in the way that is connects each of the servers together. For example, rather than each server 306 being directly connected to every other server in the rack 302 via dashed line 307, each consecutive pair of servers 306 may be directly coupled together, thereby forming a daisy-chain style direct wireless connection across all of the servers 306.

System 300 may further include a wireless router 310 and a wire-based network switch 312, each of known type but potentially programmed to function as disclosed herein. The wireless router 310 may be a networking device that is used to forward data packets between computer networks using a Wi-Fi or other type of wireless connection. Moreover, switch 312 may be a computer networking device that connects devices together over an Ethernet connection or the like, e.g., by using packet switching to receive, process and forward data to the destination device.

It follows that either or both of the wireless router 310 and the wire-based network switch 312 may be used to form a network access point. According to the present description, a “network access point” is intended to serve as a point at which connection to a network may be achieved, e.g., such as a wide area network (WAN), the Internet, a global area network (GAN), a fiber-based network, etc., or any other form of network which allows different nodes to share resources (e.g., information), as would be appreciated by one skilled in the art upon reading the present description.

With continued reference to the embodiment illustrated in FIG. 3, one of the servers 306 is illustrated as being physically coupled to the wire-based network switch 312. The physical electrical connection 314 used to couple the server 306 to the wire-based network switch 312 may include a cable, a wire, a bus, etc. It should be noted that although one of the servers 306 is illustrated as being physically coupled to the wire-based network switch 312, more or fewer of the servers 306 may be coupled to the wire-based network switch 312 via physical electrical connections. Moreover, one or more servers 306 may be coupled to the wireless router 310 using a physical electrical connection in some approaches.

Together, the physical electrical connection 314 and the direct wireless connection (e.g., see dashed line 307) that may be formed between each of the servers 306 may be used to achieve effective data transfer between each of the servers 306 and a network access point (e.g., wireless router 310 and/or wire-based network switch 312). This functionality may be achieved by implementing various approaches described herein. For example, any one or more of the processes described in method 400 and/or method 500 below may be applied to system 300 as would be appreciated by one skilled in the art upon reading the present description. According to an illustrative approach, a processor, controller, computing component, etc., may be implemented in one or more of the servers 306 of FIG. 3, which may be used to perform any one or more of the processes described in method 400 and/or method 500 below.

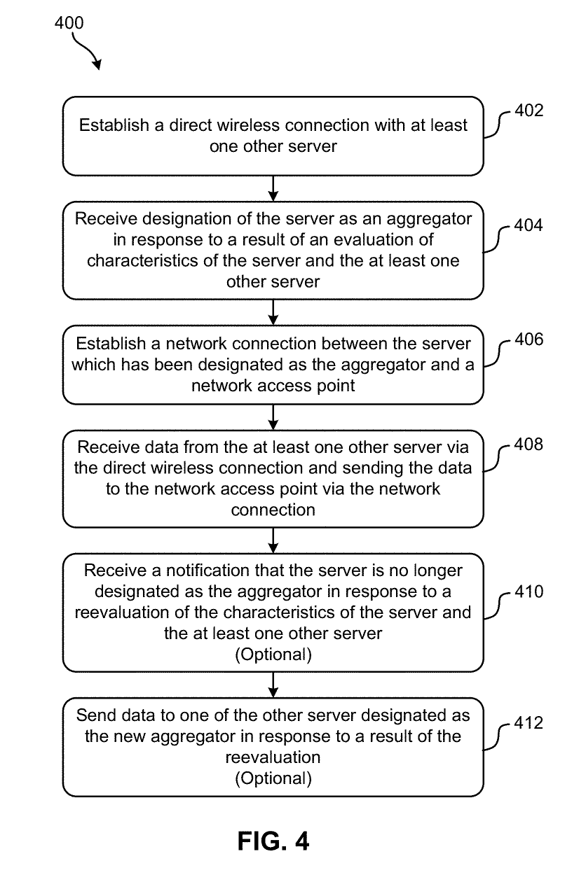

Looking now to FIG. 4, a flowchart of a method 400 is shown according to one embodiment. The method 400 may be performed in accordance with the present invention in any of the environments depicted in FIGS. 1-3, among others, in various embodiments. Of course, more or less operations than those specifically described in FIG. 4 may be included in method 400, as would be understood by one of skill in the art upon reading the present descriptions.

Each of the steps of the method 400 may be performed by any suitable component of the operating environment. For example, in various embodiments, the method 400 may be partially or entirely performed by a controller, a processor, etc., or some other device having one or more processors therein, e.g., such as a server (see 306 of FIG. 3). The processor, e.g., processing circuit(s), chip(s), and/or module(s) implemented in hardware and/or software, and preferably having at least one hardware component may be utilized in any device to perform one or more steps of the method 400. Illustrative processors include, but are not limited to, a central processing unit (CPU), an application specific integrated circuit (ASIC), a field programmable gate array (FPGA), etc., combinations thereof, or any other suitable computing device known in the art.

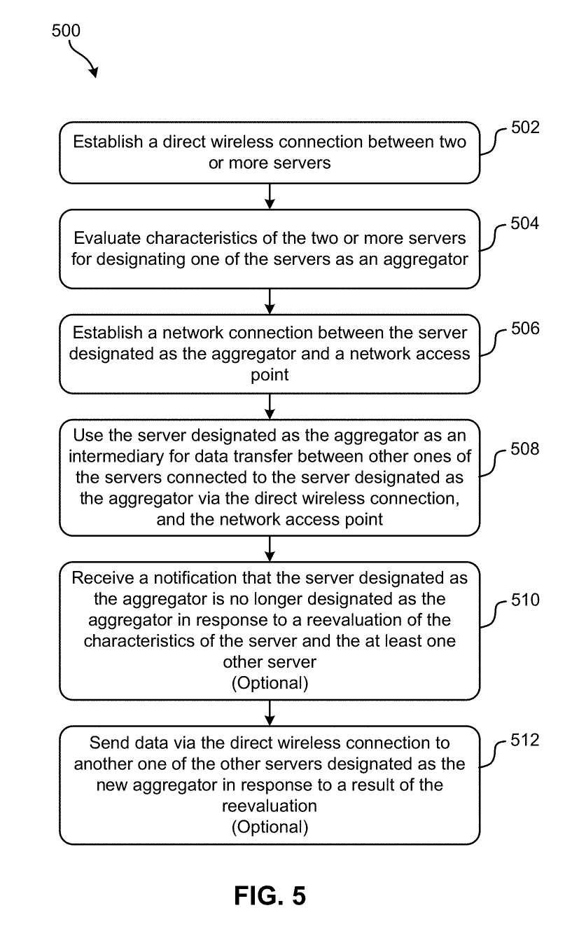

It should be noted that the processes included in method 400 may be performed by one of the servers in a server rack. Thus, the steps included in the processes are written from the perspective of the performing server. However, this is in no way intended to be limiting, but rather is presented by way of example. For instance, one or more of the processes included in method 400 may generally be performed by a controller coupled to the system and used to manage the components included therein, e.g., see method 500 of FIG. 5 below.

Referring again to FIG. 4, operation 402 of method 400 includes establishing a direct wireless connection with at least one other server, e.g., a second server; second and third servers; second, third and fourth servers; etc. In some approaches the at least one other server coupled to the direct wireless connection may be in the same server rack. Thus, the server and the at least one other server may be coupled to a common enclosure. However, it is preferred, but in no way required, that the server and the at least one other server are not coupled to each other by a physical electrical connection.

As mentioned above, depending on the dimensions and configuration of a server rack, a plurality of servers may be included (e.g., stored) in the server rack. Moreover, each of the servers may have a wireless communication device that may be used to establish a direct wireless connection between the servers (e.g., see 307 of FIG. 3). Again, a “direct wireless connection” may include any type of wireless connection that is established using a protocol that does not implement a wireless access point, e.g., such as Bluetooth, near field communication, Wi-Fi Direct, etc. However, it should be noted that in some approaches, operation 402 may alternatively include establishing a wireless connection that does implement a wireless access point, e.g., such as Wi-Fi. Moreover, it should be noted that in some approaches, the at least one other server coupled to the direct wireless connection may not be in the same server rack, e.g., may be stored in a different server rack that is in range of the direct wireless connection.

After the direct wireless connection is established, operation 404 includes receiving designation of the server as an aggregator in response to a result of an evaluation of characteristics of the server and the at least one other server. The server designated as the aggregator effectively acts as an intermediary between a network access point and a number of other servers in the rack. The connection between the aggregator and the remaining servers is preferably achieved via the direct wireless connection therebetween, while the connection between the aggregator and the network access point may be via a physical electrical connection, e.g., as will be described in further detail below. As a result, many of the servers stored in a rack may effectively be coupled to a network access point while also minimizing the amount of physical electrical connections implemented to achieve such an interconnection. Again, reducing the amount of physical electrical connections in a server rack may desirably decrease the likelihood of crossed or faulty cables, increase airflow, increase the achievable server density, reduce fabrication costs, etc.

Designating a server as an aggregator is preferably based on the result of an evaluation of characteristics of the servers in a given area, e.g., in a particular server rack. More specifically, designating a server as an aggregator is preferably based on the result of an evaluation of characteristics of the servers that are connected to the direct wireless connection, and thereby in a given area that corresponds to the effective range of the direct wireless connection. It follows that multiple servers may eligible for selection as the designated aggregator.

The server that best matches predetermined conditions, user preferences, a preset program, updated system settings, etc., may be designated as the aggregator. According to various approaches, the characteristics evaluated in order to designate a server as an aggregator may include, but are not limited to, user preferences; existence of a wired connection from the server to the network access point; an inventory of each of the servers; hardware properties, e.g., such as relative age, generation, firmware version, etc.; etc. According to an illustrative approach, which is in no way intended to limit the invention, a primary consideration in choosing whether a server is to be designated as the aggregator includes determining whether the server has a physical electrical connection to a network access point, e.g., see server 306 coupled to wire-based network switch 312 via physical electrical connection 314 which may be a wired Ethernet connection. If such a physical electrical connection exists between the network access point and one of the servers, the respective server may be designated as the aggregator. The existing physical electrical connection may be utilized to improve data transfer rates, reduce error rates, reduce complexity, etc. In some approaches, a physical electrical connection may be formed between one of the servers and a network access point prior to and/or after selecting the one of the servers as the aggregate. However, it should also be noted that in some approaches, a randomly selected server may be designated as the aggregator.

As mentioned above, the server designated as the aggregator is preferably one of the servers coupled to the direct wireless connection either wirelessly or via a physical electrical connection. It follows that one or more of the servers themselves may ultimately evaluate the characteristics and/or select which server is ultimately designated as the aggregator. For example, all servers connected to the direct wireless connection may collectively evaluate the characteristics and select (e.g., vote on) one of them to be designated as the aggregator. However, it should again be noted that in some approaches, the servers may randomly select the server to designate as the aggregator, e.g., without considering the characteristics thereof. For example, a random number generator may be used to assign a random number to each of the servers, whereby the server with the highest number value, lowest number value, middle number value, etc., may be designated as the aggregator.

In some approaches, at least some of the characteristics of the servers being evaluated may be exchanged between the servers via the direct wireless connection. In one example, near field communication may be used to establish a connection between nearby servers, whereby information (characteristics) may be exchanged therebetween. Moreover, the characteristics may be stored in a lookup table for easy access, for future use, to be updated over time, etc. The lookup table may be stored in one of the servers, in memory coupled to the server rack, memory also coupled to the direct wireless connection, etc., depending on the desired approach.

It should also be noted that characteristics of the aggregator and/or other servers may continue to be evaluated even after an aggregator has been designated. For example, looking momentarily to FIG. 5, processes of monitoring and reevaluating server characteristics is presented, and will be described in further detail below.

Referring again to method 400 of FIG. 4, operation 406 includes establishing a network connection between the server (which has been designated as the aggregator) and a network access point. According to different approaches, a network access point may include a wire-based network switch, a wireless router, a fiber connection, etc. Thus, depending on the approach, the network connection between the aggregator and the network access point may be established differently. For example, a network connection between the aggregator and an Ethernet switch network access point may be established via a wired Ethernet connection extending therebetween. According to another example, a network connection between the aggregator and a wireless router network access point may be established by establishing a Wi-Fi connection between the aggregator and the wireless router, as would be appreciated by one skilled in the art upon reading the present description.

Furthermore, operation 408 includes the server receiving data from the at least one other server via the direct wireless connection, and sending the data to the network access point via the network connection. Again, the server designated as the aggregator may serve as an intermediary between the network access point and the other servers coupled to the direct wireless connection. It follows that any data, commands, files, etc., being transferred from any of the servers coupled to the direct wireless connection to the network access point, may be routed through the server designated as the aggregator. As such, any data, commands, files, etc., being transferred from any of the servers coupled to the direct wireless connection to the network access point may be received by the aggregator from the respective server via the direct wireless connection, and sent to the network access point from the aggregator via the network connection established in operation 406.

Similarly, any data, commands, files, etc., being transferred from the network access point to any of the servers coupled to the direct wireless connection may be routed through the server designated as the aggregator. Therefore, any data, commands, files, etc., being transferred from the network access point to any of the servers coupled to the direct wireless connection may be received by the aggregator from the network access point via the network connection established in operation 406, and sent from the aggregator to the respective server via the direct wireless connection.

Referring still to method 400, optional operation 410 includes receiving a notification that the server is no longer designated as the aggregator in response to a reevaluation of the characteristics of the server and the at least one other server. Again, characteristics of the aggregator and/or the other servers connected to the direct wireless connection may continue to be evaluated over time, even after an aggregator has been designated. According to different approaches, the characteristics may be reevaluated after an amount of time has passed, upon receiving a request from a user, in response to the server designated as the aggregator failing to respond according to a predetermined condition, according to a preset program, etc. For example, looking momentarily to FIG. 5, processes of monitoring and reevaluating server characteristics is presented, and will be described in further detail below.

Thus, in the event a determination is made that a server designated as the aggregator should be replaced as the aggregator, the server may receive a notification of this change and returned to a normal, non-aggregator state. The server formerly designated as the aggregator may begin sending data to and/or receiving data from the server designated as the new aggregator. Accordingly, optional operation 412 includes sending data to one of the other server designated as the new aggregator in response to a result of the reevaluation. The data may be sent to the server designated as the new aggregator via the direct wireless connection, as the server designated as the new aggregator is preferably one of the other servers also connected to the direct wireless connection.

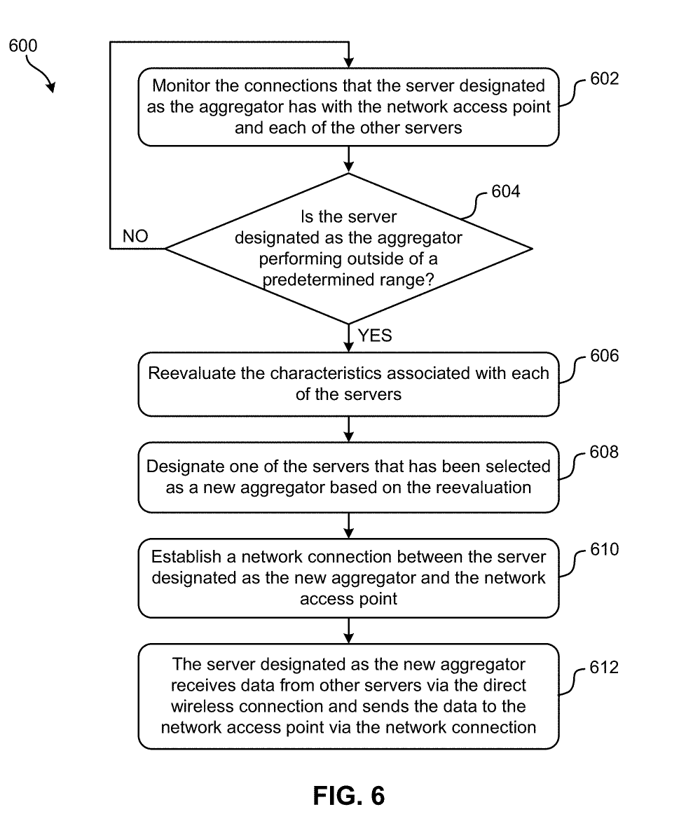

As noted above, method 400 of FIG. 4 has been written from the perspective of a server designated as the aggregator. It follows that the processes included in method 400 may be performed by a server, or a processor, computing component, controller, etc. integrated therewith. FIGS. 5-6 present alternate embodiments which are written from the perspective of a single system having servers and a network access point (e.g., such as system 300). Thus, it should be noted that any one or more of the processes described below in relation to FIGS. 5-6 may be performed by a processor, computing component, controller, etc. integrated with such a system.

Looking now to FIG. 5, a flowchart of a method 500 is shown according to one embodiment. The method 500 may be performed in accordance with the present invention in any of the environments depicted in FIGS. 1-3, among others, in various embodiments. Of course, more or less operations than those specifically described in FIG. 5 may be included in method 500, as would be understood by one of skill in the art upon reading the present descriptions.

Each of the steps of the method 500 may be performed by any suitable component of the operating environment. For example, in various embodiments, the method 500 may be partially or entirely performed by a controller, a processor, etc., or some other device having one or more processors therein, e.g., such as a server (see 306 of FIG. 3). The processor, e.g., processing circuit(s), chip(s), and/or module(s) implemented in hardware and/or software, and preferably having at least one hardware component may be utilized in any device to perform one or more steps of the method 500. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 5, operation 502 of method 500 includes establishing a direct wireless connection between two or more servers. It follows that the two or more servers are preferably in an effective communication range of each other (e.g., in the same storage rack) in order for the direct wireless connection to be established therebetween. Moreover, the direct wireless connection may be established according to any of the approaches described herein. For example, the direct wireless connection may be established using a protocol such as Bluetooth, near field communication, Wi-Fi Direct, etc.

Operation 504 includes evaluating characteristics of the two or more servers for designating one of the servers as an aggregator. Again, the characteristics evaluated may include user preferences; existence of a wired connection from the server to the network access point; an inventory of each of the servers; hardware properties, e.g., such as age, generation, firmware version, etc.; etc. Moreover, the characteristics may be evaluated according to any of the approaches described herein. According to an illustrative approach, which is in no way intended to limit the invention, a primary consideration in choosing whether a server is to be designated as the aggregator includes determining whether the server has a physical electrical connection to a network access point. A server may be designated as the aggregator in response to determining that a physical electrical connection exists between the network access point and that server. However, it should also be noted that in some approaches, a randomly selected server may be designated as the aggregator.

Furthermore, operation 506 includes establishing a network connection between the server designated as the aggregator and a network access point, while operation 508 includes using the server designated as the aggregator as an intermediary for data transfer between other ones of the servers connected to the server designated as the aggregator via the direct wireless connection, and the network access point. The network connection may also include any of the network connection types described and/or suggested herein depending on the desired approach.

Optional operation 510 includes receiving a notification that the server designated as the aggregator is no longer designated as the aggregator in response to a reevaluation of the characteristics of the server and the at least one other server. As mentioned above, server characteristics may be monitored and reevaluated even after one of the servers has been designated as the aggregator. Implementing monitoring and/or reevaluation processes may improve the system's overall ability to adapt to changing conditions (e.g., characteristics) and maintain efficiency.

Looking momentarily to FIG. 6, exemplary sub-processes of a method 600 for performing a reevaluation are illustrated in accordance with one embodiment, one or more of which may be used in relation to performing operation 510 of FIG. 5. However, it should be noted that the sub-processes of FIG. 6 are illustrated in accordance with one embodiment which is in no way intended to limit the invention.

As shown in FIG. 6, sub-process 602 includes monitoring the connections that the server designated as the aggregator has with the network access point and each of the other servers. In other words, sub-process 602 includes monitoring the network connection and the direct wireless connection. By monitoring the connections existing with the server designated as the aggregator, the performance of the server designated as the aggregator may be monitored as well. For instance, if a data transfer error rate between the network access point and the server designated as the aggregator rises above a range, it may be determined that the server designated as the aggregator has malfunctioned. Moreover, by monitoring the connections in a system, sub-process 602 may be able to detect when new servers are introduced in a rack, when servers are removed from a rack, when another rack is positioned within a range of an existing rack, etc.

Accordingly, decision 604 includes determining whether the server designated as the aggregator is performing outside of a predetermined range. Depending on the approach, the predetermined range may include a set data transfer error rate, a given response delay time, experiencing a predetermined amount of backlogging, etc. For instance, decision 604 may include determining whether the server designated as the aggregator and/or the network access point has failed to respond according to a predetermined condition (e.g., within a predetermined amount of time). In another example, decision 604 may include determining whether the server designated as the aggregator has become overly taxed due to a high amount of system activity, thereby causing the server to become backlogged. For instance, as the basepoint management controller of a server becomes overly taxed, performance of the server as a whole may suffer (become slower). Accordingly, processes assigned to a server designated as the aggregator may preferably be offloaded and assigned to another one of the servers, preferably in order to increase system efficiency.

Moreover, it should be noted that “outside of a predetermined range” is in no way intended to limit the invention. Rather than determining whether a value is outside of a predetermined range, equivalent determinations may be made, e.g., as to whether a value is above a threshold, whether a value is outside a predetermined range, whether an absolute value is above a threshold, whether a value is below a threshold, etc., depending on the desired approach.

In response to determining that the server designated as the aggregator is not performing outside of a predetermined range, method 600 may return to sub-process 602 whereby monitoring of conditions may continue. However, method 600 proceeds to sub-process 606 in response to determining that the server designated as the aggregator is performing outside of the predetermined range. As shown, sub-process 606 includes reevaluating the characteristics associated with each of the servers, preferably including the server currently designated as the aggregator.

The reevaluation performed in sub-process 606 may be performed in the same, or a similar manner, as an initial evaluation of the characteristics according to any of the approaches described herein. Thus, the server that best matches criteria such as predetermined conditions, user preferences, a preset program, updated system settings, etc., may be designated as the aggregator. According to various approaches, the characteristics evaluated in order to designate a server as an aggregator may include, but are not limited to, user preferences; existence of a wired connection from the server to the network access point; an inventory of each of the servers; hardware properties, e.g., such as age, generation, firmware version, etc.; etc.

Sub-process 608 further includes designating one of the servers that has been selected as a new (updated) aggregator based on the reevaluation. The server ultimately selected to be designated as the new aggregator may likely be a different server than the one previously designated as the aggregator. In some instances, the characteristics corresponding to one or more other servers may have become more favorable than those of the server previously designated as the aggregator. Thus, it may be desirable that a different one of the servers is designated as the aggregator, while the server currently designated as the aggregator is stripped of its status of aggregator.

One or more of the servers themselves may ultimately reevaluate the characteristics and/or select which server is ultimately designated as the new aggregator. For example, all servers connected together via a direct wireless connection may collectively evaluate the characteristics and select (e.g., vote on) one of them to be designated as the new aggregator. In some approaches, the characteristics used in the reevaluation may be accessed from a lookup table where they may have previously been stored, e.g., as described above.

Once the one of the servers has been selected and designated as the new aggregator, a network connection between the server designated as the new aggregator and the network access point may be established. See sub-process 610. The network connection may be established according to any of the approaches described herein.

Furthermore, sub-process 612 includes the server designated as the new aggregator receiving data from other servers via the direct wireless connection and sending the data to the network access point via the network connection. The server designated as the new aggregator may serve as an intermediary between the network access point and the other servers coupled to the direct wireless connection. It follows that any data, commands, files, etc., being transferred from any of the servers coupled to the direct wireless connection to the network access point, may now be routed through the server designated as the new aggregator. As such, any data, commands, files, etc., being transferred from any of the servers coupled to the direct wireless connection to the network access point may be received by the aggregator from the respective server via the direct wireless connection, and sent to the network access point from the new aggregator via the network connection established in sub-process 610.

Similarly, any data, commands, files, etc., being transferred from the network access point to any of the servers coupled to the direct wireless connection may now be routed through the server designated as the new aggregator. Therefore, any data, commands, files, etc., being transferred from the network access point to any of the servers coupled to the direct wireless connection may be received by the new aggregator from the network access point via the network connection established in sub-process 610, and sent from the aggregator to the respective server via the direct wireless connection.

Referring back to FIG. 5, optional operation 512 includes sending data via the direct wireless connection to the server designated as the new aggregator in response to a result of the reevaluation.

It follows that various embodiments described herein may enable the ability to manage multiple servers in a rack without implementing physical electrical connections to each of the multiple servers. Rather, by implementing direct wireless connections (e.g., such as Wi-Fi Direct), a protocol that allows for one or more systems to conduct communication without implementing a router, thereby achieving a less expensive way to manage a plethora of servers. According to an exemplary embodiment, an inexpensive Wi-Fi communication device and/or Wi-Fi IC may be used to replace the use of components such as Ethernet PHY IC's and/or RJ45 connectors found on the motherboard of conventional implementations. This improvement also offers a way to dynamically select the network access point such that redundancy and availability are achieved in an enterprise class systems. By implementing some of the approaches described and/or suggested herein, a novel architecture for managing a plurality of servers in a rack with a reduced use of management cables may be achieved. The benefits associated with such achievements include faster setup times and reduced hardware costs.

The inventive concepts disclosed herein have been presented by way of example to illustrate the myriad features thereof in a plurality of illustrative scenarios, embodiments, and/or implementations. It should be appreciated that the concepts generally disclosed are to be considered as modular, and may be implemented in any combination, permutation, or synthesis thereof. In addition, any modification, alteration, or equivalent of the presently disclosed features, functions, and concepts that would be appreciated by a person having ordinary skill in the art upon reading the instant descriptions should also be considered within the scope of this disclosure.

While various embodiments have been described above, it should be understood that they have been presented by way of example only, and not limitation. Thus, the breadth and scope of an embodiment of the present invention should not be limited by any of the above-described exemplary embodiments, but should be defined only in accordance with the following claims and their equivalents.

What is claimed is:

1. A method, comprising:
establishing, by a server, a direct wireless connection with a second server;
receiving, by the server, designation of the server as an aggregator in response to a result of an evaluation of characteristics of the server and the second server;
establishing, by the server, a network connection between the server and a network access point; and
receiving, by the server, data from the second server via the direct wireless connection and sending the data to the network access point via the network connection.

2. The method as recited in claim 1, wherein the direct wireless connection is established using a protocol selected from a group consisting of: Bluetooth, near field communication and Wi-Fi Direct.

3. The method as recited in claim 1, wherein the characteristics are selected from a group consisting of: user preferences, existence of a wired connection to the network access point, an inventory of each of the servers, and hardware properties.

4. The method as recited in claim 3, wherein at least some of the characteristics of the server and the second server are exchanged between the servers via the direct wireless connection.

5. The method as recited in claim 1, wherein the server is designated as the aggregator in response to the evaluation determining that the server has a physical electrical connection to a wire-based network switch.

6. The method as recited in claim 1, comprising:
receiving, by the server, a notification that the server is no longer designated as the aggregator in response to a reevaluation of the characteristics of the server and the second server, wherein the second server is designated as a new aggregator in response to a result of the reevaluation; and
sending, by the server, data to the second server in response to designation of the second server as the new aggregator, wherein the data is sent to the server via the direct wireless connection.

7. The method as recited in claim 6, wherein the reevaluation is performed in response to the server designated as the aggregator failing to respond according to a predetermined condition.

8. The method as recited in claim 1, wherein the server and the second server are coupled to a common enclosure.

9. A computer program product comprising a computer readable storage medium having program instructions embodied therewith, the program instructions executable by a server to perform a method comprising:
establishing, by the server, a direct wireless connection with a second server;
receiving, by the server, designation of the server as an aggregator in response to a result of an evaluation of characteristics of the server and the second server;
establishing, by the server, a network connection between the server and a network access point; and
receiving, by the server, data from the second server via the direct wireless connection and sending the data to the network access point via the network connection.

10. The computer program product as recited in claim 9, wherein the direct wireless connection is established using a protocol selected from a group consisting of: Bluetooth, near field communication and Wi-Fi Direct.

11. The computer program product as recited in claim 9, wherein the characteristics are selected from a group consisting of: user preferences, existence of a wired connection to the network access point, an inventory of each of the servers, and hardware properties.

12. The computer program product as recited in claim 11, wherein at least some of the characteristics of the server and the second server are exchanged between the servers via the direct wireless connection.

13. The computer program product as recited in claim 9, wherein the server is designated as the aggregator in response to the evaluation determining that the server has a physical electrical connection to a wire-based network switch.

14. The computer program product as recited in claim 9, the method comprising:
receiving, by the server, a notification that the server is no longer designated as the aggregator in response to a reevaluation of the characteristics of the server and the second server, wherein the second server is designated as a new aggregator in response to a result of the reevaluation; and
sending, by the server, data to the second server in response to designation of the second server as the new aggregator, wherein the data is sent to the server designated as the new aggregator via the direct wireless connection.

15. The computer program product as recited in claim 14, wherein the reevaluation is performed in response to the server designated as the aggregator failing to respond according to a predetermined condition.

16. The computer program product as recited in claim 9, wherein the server and the second server are coupled to a common enclosure.

17. A method, comprising:
establishing a direct wireless connection between two or more servers;
evaluating characteristics of the two or more servers for designating one of the servers as an aggregator;
establishing a network connection between the server designated as the aggregator and a network access point; and
using the server designated as the aggregator as an intermediary for data transfer between other ones of the servers connected to the server designated as the aggregator via the direct wireless connection, and the network access point.

18. The method as recited in claim 17, wherein the direct wireless connection is established using a protocol selected from a group consisting of: Bluetooth, near field communication and Wi-Fi Direct.

19. The method as recited in claim 17, wherein the characteristics are selected from a group consisting of: user preferences, existence of a wired connection to the network access point, an inventory of each of the servers, and hardware properties.

20. The method as recited in claim 17, comprising:
receiving, by the server, a notification that the server designated as the aggregator is no longer designated as the aggregator in response to a reevaluation of the characteristics of the server and the at least one other server; and
sending, by the server, data to another one of the two or more servers designated as a new aggregator in response to a result of the reevaluation, wherein the data is sent to the another one of the two or more servers designated as the new aggregator via the direct wireless connection.
